(19) United States
(12) Patent Application Publication
(10) Pub. No.: US 2026/0304048 A1
(43) Pub. Date: Oct. 1, 2026

(54) AI-BASED AUTOMATIC STEERING FOR HEARING DEVICES

(71) Applicant: Sonova AG, Staefa (CH)

(72) Inventors: Ruksana Giurda, Hombrechtikon (CH); Simone Lionetti, Wallisellen (CH); Fabian Groeger, Kriens (CH)

(21) Appl. No.: 19/094,101

(22) Filed: Mar. 28, 2025

(51) Int. Cl. H04R 25/00

(52) U.S. Cl. CPC H04R 25/507; H04R 2225/41; H04R 2225/43

(57) ABSTRACT

A hearing device includes an input device, an output device, a processor, and a memory having non-transitory computer-readable instructions for automatically steering the hearing device. The hearing device is configured to receive an audio signal via the input device, generate a first set of embeddings based on the audio signal, transform the first set of embeddings to a second set of embeddings, select a region of a plurality of regions based on the second set of embeddings, process the audio signal with one or more signal processing transformations associated with the region, and render the processed audio signal with the output device. The first set of embeddings are associated with a first embedding space. The second set of embeddings are associated with a second embedding space, which includes the plurality of regions.

### TECHNICAL FIELD

The present disclosure relates to hearing devices and, more particularly, to methods and apparatuses for artificial intelligence-based automatic steering for hearing devices.

### BACKGROUND

Hearing devices may be used to improve the hearing capability or communication capability of a user, for instance, by compensating a hearing loss of a hearing-impaired user, in which case the hearing device is commonly referred to as a hearing instrument such as a hearing aid or hearing prosthesis, or to adapt the sound to the preferences or the situational needs of a user. A hearing device may also be used to output sound based on an audio signal, which may be communicated by a wire or wirelessly to the hearing device. A hearing device may also be used to reproduce a sound in a user's ear canal detected by an input transducer, such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise canceling (ANC), with or without amplification of the reproduced sound. A hearing device may also be implemented as a hearing protection device, such as an earplug, configured to protect the user's hearing. Different types of hearing devices configured to be be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device. A hearing system may also comprise a hearing device, e.g., a single monaural hearing device or a binaural hearing device; a user device, e.g., a smartphone and/or a smartwatch, communicatively coupled to the hearing device; and/or an external device, e.g., a television connector, sound system connector, a Roger™ wireless microphone.

As such, hearing devices may be employed in conjunction with various user or external devices, which may take the form of smartphones or tablets, for instance when listening to sound data processed by the communication device and/or during a phone conversation operated by the communication device. More recently, communication devices have been integrated with hearing devices such that the hearing devices at least partially comprise the functionality of those user or external devices. A hearing system may therefore comprise, for instance, hearing device(s), user device(s), and/or external device(s).

### SUMMARY

Hearing devices offer a diversified portfolio of actuators to provide the best possible steering in a variety of acoustic conditions. However, existing steering processes for hearing devices rely on predefined acoustic programs, which may be determined through a supervised learning approach based on sound classification. This approach presents several limitations.

First, sound classification in existing steering processes depends on human-defined categories of audio environments, which may not optimally correspond to the actual acoustic properties present in real-world situations. These classifications (e.g., “speech in noise”, “quiet”, “music”) are inherently arbitrary and fail to capture the nuanced variations in sound that are relevant for optimal hearing device performance. Traditionally, classifiers are trained with labeled data, where each input sound is assigned a predefined category, and corresponding predefined actuator configurations are applied based on that category. However, this method assumes that the predefined categories are the best way to cluster sounds, which may not always be the case.

Another issue is that supervised classification imposes constraints on the learning process, as the learning algorithm is forced to learn distinctions that may not reflect the most relevant acoustic characteristics. This means that certain features of the sound may be overlooked simply because they do not align with human-imposed labels. Historically, improvements in classification have been achieved by refining the training data and improving the quality of labeling, but this still does not address the problem of bias in human-defined categories.

Furthermore, sound classification models may not generalize well to unseen environments, as they are trained on a limited dataset that may not encompass all real-world acoustic scenarios. Consequently, hearing devices may struggle to steer optimally in unfamiliar situations. Existing approaches assume that the best way to process sound is already known, whereas in reality, a more flexible and data-driven method may uncover more meaningful ways to process audio signals.

As such, it is an object of the present disclosure to provide real time, automatic steering of the hearing device without human supervision. The automatic steering system described herein addresses the foregoing limitations by shifting from a supervised learning approach based on predefined sound categorization to an unsupervised representation learning approach. Instead of categorizing audio into human-defined groups, the system allows the steering algorithm to analyze and cluster sound data based the inherent acoustic properties of the sound data. This means that rather than relying on potentially arbitrary or suboptimal classifications, the system can identify salient patterns and similarities in the sound data for optimizing the listening experience. In this manner, the previous need to map audio into predefined actuator settings for steering is reduced, as the system directly links regions in the learned representation space to specific actuator settings. This direct mapping reduces the number of abstraction layers, making the response to different acoustic environments more fluid and adaptable. This may imply that actuators which could be attributed to common classifications can be determined automatically. Historically, this approach has not been used because hearing device technology has largely depended on human expertise to define what constitutes different listening environments. Supervised learning aligned with how humans categorize sounds, and it was simpler to implement given the availability of labeled data. However, various embodiments herein provide for systems that utilize representation learning that can independently learn meaningful distinctions in data without human intervention.

The advantages of the implementations described herein can be achieved, for example, by a method comprising the features of patent claim 1 and/or by an apparatus (e.g., a hearing device) comprising the features of patent claim 12. The advantages of the implementations described herein can also be achieved, for example, by a non-transitory computer-readable medium comprising the features of patent claim 18. Further advantageous embodiments are defined by the dependent claims and the following description.

Accordingly, the present disclosure proposes a method for automatically steering a hearing device comprising:
projecting an input audio signal into a partitioned embedding space to form a set of embeddings, wherein the partitioned embedding space includes a plurality of regions;
identifying a region of the plurality of regions corresponding to the set of embeddings, wherein the region corresponds to one or more signal processing transformations; and
applying, to the hearing device, the one or more signal processing transformations to the input audio signal to output a processed audio signal.

Thus, various actuator settings can be applied based on the identified plurality of regions, where the actuators are used to apply one or more audio signal processing transformations to an input audio signal of a hearing device. A processed audio signal according to the one or more audio signal processing transformations may therefore be output that reflects the actuator settings determined by the automatic steering method. The methods described herein may be implemented on any computing device (or combination of computing devices) on which instructions for running software are stored and/or executed (e.g., a hearing device; a personal computer; table computing device; computer terminal; distributed computer system including some or all of servers, clients, etc. communicating over the internet, an intranet, or any other network; mobile computing devices such as mobile phones, dedicated handheld devices, wearable devices (e.g. smartwatches, smart glasses, etc.); a hearing device, user device, and/or external device as described herein itself/themselves; etc.). Similarly, a hearing device described herein may also be implemented using any such computing device (or combination of computing devices).

Independently, the present disclosure also proposes a hearing device comprising:
an input device;
an output device;
a processor; and
a memory having non-transitory computer-readable instructions for automatically steering the hearing device, wherein, upon execution of the instructions, the processor is configured to:
receive an audio signal via the input device;
   generate a first set of embeddings based on the audio signal, the first set of embeddings are associated with a first embedding space;
transform the first set of embeddings to a second set of embeddings, the second set of embeddings are associated with a second embedding space, the second embedding space includes a plurality of regions;
select a region of the plurality of regions based on the second set of embeddings;
process the audio signal with one or more signal processing transformations associated with the region; and
render the processed audio signal with the output device.
   Thus, a hearing device can receive an input audio signal, automatically process that input audio signal to determine various actuator settings, and use actuators with the determined actuator settings to perform one or more signal processing transformations. A processed audio signal according to the one or more audio signal processing transformations may therefore be output that reflects the actuator settings determined by using automatic steering and based on an audio signal received at an input device.

The present disclosure also proposes a non-transitory computer-readable medium storing instructions for training a machine learning model that, when executed by a processor, which may be included in a computing device (e.g., a server), cause the computing device to perform operations comprising:
applying one or more first signal processing transformations to audio samples of a training audio dataset to generate an expanded audio dataset, wherein the one or more first signal processing transformations are applied at one or more predetermined levels, and each audio sample of the expanded audio dataset is associated with a sound quality metric value;
generating a first set of embeddings by mapping the expanded audio dataset to a high-dimensional embedding space, wherein each audio sample of the expanded audio dataset is associated with an embedding in the first set of embeddings;
projecting the first set of embeddings into a low-dimensional embedding space to transform the first set of embeddings into a second set of embeddings, wherein each audio sample of the expanded audio dataset is associated with an embedding in the second set of embeddings;
partitioning the low-dimensional embedding space into a plurality of regions, wherein each region is associated with a subset of the second set of embeddings;
assigning a representative sound quality metric value to each region based on sound quality metric values associated with audio samples within each region; and
determining and assigning one or more second signal processing transformations to each region, wherein the one or more second signal processing transformations increase the respective sound quality metric value for each region.
   Thus, various embodiments described herein further provide for methods, instructions stored on computer-readable mediums, and systems/apparatuses for training a machine learning model that is implementable in a hearing device to receive and process input audio signals by adjusting actuator settings using the trained machine learning model.

Additional features of some implementations of the method of automatically steering a hearing device and/or the hearing device are described. Each of those features can be provided solely or in combination with at least another feature. The features can be correspondingly provided in some implementations of the methods and/or apparatuses described herein.

In some implementations, projecting the input audio signal to the partitioned embedding space includes:
generating a first set of embeddings by mapping the input audio signal to a first embedding space; and
projecting the first set of embeddings into a second embedding space to transform the first set of embeddings into a second set of embeddings, wherein the second embedding space is the partitioned embedding space and the second set of embeddings is the set of embeddings.

In some implementations, the first embedding space is a high-dimensional embedding space and the second embedding space is a low-dimensional embedding space.

In some implementations, projecting the first set of embeddings to the second embedding space is performed by a machine learning model, the machine learning model comprising a projector and a regressor.

In some implementations, the partitioned embedding space is a hypersphere.

In some implementations, the one or more signal processing transformations include one or more of beamforming, noise cancelation, or speech enhancement.

In some implementations, the one or more signal processing transformations include one or more relative strengths each associated with one or more actuators of the hearing device.

In some implementations, the plurality of regions of the partitioned embedding space are Voronoi cells based on a plurality of random points. In some implementations, the Voronoi cells are provided on a hypersphere, wherein the random points are uniformly distributed on the hypersphere.

In some implementations, the one or more signal processing transformations corresponding to the region are associated with a representative sound quality metric value of the region, the region corresponds to a plurality of historical embeddings, the plurality of historical embeddings are associated with a plurality of historical audio signals, the representative sound quality metric value is based on a plurality of sound quality metric values corresponding to the plurality of historical audio signals, and the one or more signal processing transformations increases the representative sound quality metric value.

In some implementations, the sound quality metric is representative of one or more of a speech intelligibility, a spatial sound distortion, a consistency in a binaural audio processing, or a measure of human sound perception.

In some implementations, the representative sound quality metric value associated with the region is an average of sound quality metric values of the plurality of historical audio signals associated with the region.

In some implementations, the method and/or operations further include:
receiving a second segment of the real-time audio stream via the input device;
generating a third set of embeddings based on the second segment, the third set of embeddings are associated with the first embedding space;
transforming the third set of embeddings to a fourth set of embeddings, the fourth set of embeddings are associated with the second embedding space;
selecting a second region of the plurality of regions based on the fourth set of embeddings;
processing the second segment with one or more signal processing transformations associated with the second region; and
rendering the processed audio signal with the output device.

In some implementations, generating the first set of embeddings is performed by a first machine learning model and transforming the first set of embeddings to the second set of embeddings is performed by a second machine learning model different from the first machine learning model.

In some implementations, each region of the plurality of regions corresponds to a set of one or more signal processing transformations and a set of one or more strengths corresponding to the one or more signal processing transformations.

In some implementations, transforming the first set of embeddings to the second set of embeddings is performed by a machine learning model trained by:
applying one or more first signal processing transformations to audio samples of a training audio dataset to generate an expanded audio dataset, wherein the one or more first signal processing transformations are applied at one or more predetermined levels, and each audio sample of the expanded audio dataset is associated with a sound quality metric value;
embedding the expanded audio dataset into a set of feature vectors, wherein a feature vector represents a point in a region of the second embedding space;
assigning a representative sound quality metric value to each region of the second embedding space based on sound quality metric values of audio samples associated with each region; and
determining and assigning a set of signal processing transformations to each region by applying one or more second signal processing transformations to audio samples associated with each region, wherein the assigned set of signal processing transformations for a region is determined based on the one or more second signal processing transformations that maximize the respective sound quality metric value for the region.

In some implementations, embedding the expanded audio dataset into the set of feature vectors comprises:
mapping the expanded audio dataset to a high-dimensional embedding space to form a first set of feature vectors; and
projecting the first set of feature vectors into a low-dimensional embedding space to form a second set of feature vectors, wherein each audio sample of the expanded audio dataset is associated with a feature vector in the second set of feature vectors, and the second set of feature vectors is the set of feature vectors.

In some implementations, determining the one or more second signal processing transformations for each region includes:
selecting a representative audio sample of a region; and
applying one or more trial signal processing transformations to the representative audio sample, wherein the one or more trial signal processing transformations are applied at one or more predetermined levels, and the trial signal processing transformations that maximize the sound quality metric value of the region is the one or more second signal processing transformations.

In some implementations, determining the one or more second signal processing transformations for each region comprises:
selecting a representative audio sample of a region; and
applying one or more trial signal processing transformations to the representative audio sample, wherein the one or more trial signal processing transformations are applied at one or more predetermined levels, and the trial signal processing transformations that move the embedding of the representative audio sample to another region having a higher representative sound quality metric value is the one or more second signal processing transformations. In some implementations, the trial signal processing transformations are provided such that the embedding is moved between contiguous regions.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIG. 1 schematically illustrates a hearing system according to one or more embodiments;

FIG. 2 schematically illustrates a network environment including the hearing system of FIG. 1 according to one or more embodiments;

FIG. 3 schematically illustrates audio processing according to one or more embodiments;

FIG. 4 graphically illustrates mapping data points from an embedding space to actuator configurations according to one or more embodiments;

FIG. 5 schematically illustrates audio processing with feedback loop according to one or more embodiments;

FIG. 6A graphically illustrates a hypersphere embedding space according to one or more embodiments;

FIG. 6B graphically illustrates the hypersphere embedding space of FIG. 6A with sound quality metric values according to one or more embodiments;

FIG. 6C graphically illustrates the hypersphere embedding space of FIG. 6A with sample mapping according to one or more embodiments;

FIG. 7 illustrates a flow diagram of an example process for training a model for automatically steering a hearing system according to one or more implementations;

FIG. 8 illustrates a flow diagram of an example process for automatically steering a hearing device according to one or more implementations; and

FIG. 9 schematically illustrates an exemplary computing device.

### DETAILED DESCRIPTION OF THE DRAWINGS

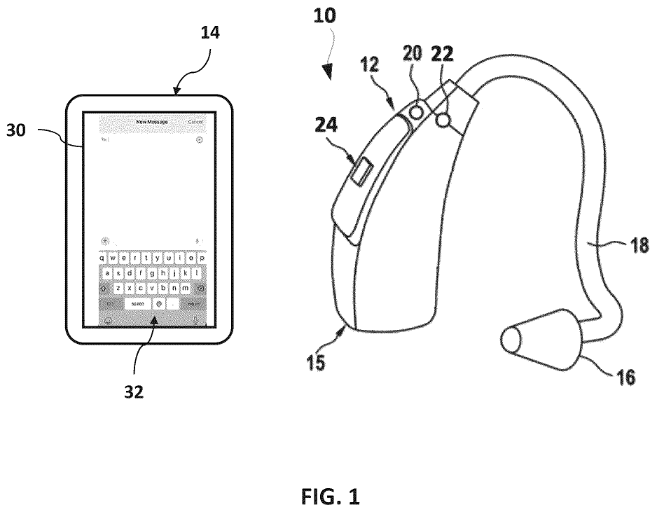

FIG. 1 schematically shows a hearing system 10 according to one or more embodiments. The hearing system 10 includes a hearing device 12 and a user device 14 connected to the hearing device 12. As an example, the hearing device 12 is formed as a behind-the-ear device carried by a user of the hearing device 12. It should be noted that the hearing device 12 is a specific embodiment and that the methods described herein also may be performed with other types of hearing devices, such as earbuds, earphones, hearables, and hearing instruments such as receiver-in-the-canal (RIC) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses; and a hearing system for a user may include one or two of the hearing devices 12 mentioned above. The user device 14 may be a smartphone, a tablet computer, smart glasses, etc.

The hearing device 12 comprises a first part 15 behind or at the ear (which may also be referred to as a behind-the-ear (BTE) part) and a second part 16 to be put in the ear canal of the user (which may also be referred to as an in-the-ear (ITE) part). The first part 15 and the second part 16 are connected by a tube 18 or cable. A cable may be used in a receiver-in-the-canal (RIC) hearing device, for example. The first part 15 comprises at least one sound detector (also referred to herein as an “input device 20”), such as a microphone or a microphone array, a sound output component 22 (also referred to herein as a “receiver” or “output device”), such as a loudspeaker, and optionally an input 24, such as a knob, a button, or a touch-sensitive sensor (e.g., capacitive sensor). The sound output component 22 may also be integrated into the second part 16. The input device 20 can detect a sound in the environment of the user and generate an audio signal indicative of the detected sound. Such an audio signal may be, for example, a voice of the user or another person such that speech of a user may be detected. The input device 20 may also be a sensor that is used to measure one or more metrics of a hearing situation (e.g., a signal level, a noise floor estimation, a signal-to-noise ratio, classified sound sources, an estimated listening intention, etc.), and such metrics may be used as dimensions to determine an embedding vector as described herein. The sound output component 22 can output sound based on the audio signal modified by the hearing device 12 in accordance with the hearing device settings, wherein the sound from the sound output component 22 is guided through the tube 18 to the second part 16 in a BTE hearing device.

In various embodiments, such as an RIC hearing device, a sound output component may be ITE and an audio signal modified by the RIC hearing device may be transmitted through a cable to a sound output component ITE. The input 24 enables an input of the user into the hearing device 12, e.g., in order to power the hearing device 12 on or off, and/or for choosing a sound program, hearing device settings, or any other modification of the audio signal. In various embodiments, the input 24 may or may not be present on the hearing device 12 itself, and a user input may be made additionally or alternatively through another device, such through a mobile application (app) on the user device 14 (e.g., a tablet computer, mobile or smartphone, smart glasses, smartwatch, etc.).

In various embodiments, an action such as powering the hearing device 12 on or off, choosing a sound program of the hearing device 12, choosing a setting of the hearing device 12, etc., may also be performed automatically by the hearing device 12 or another device such as the user device 14. Hearing device settings may be changed based on the methods and apparatuses described herein, such as based on outputs of a fitting generative pre-trained transformer (GPT) as described herein that are responsive to a natural language input of a user (e.g., where the user's natural language input is fitted to a solution by the fitting GPT).

The user device 14, which may be a smartphone, a tablet computer, smart glasses, smartwatch, etc. may include a display 30, such as a touch-sensitive display, providing a graphical user interface 32 including control element 32, such as a keyboard for entering natural language text, which may be controlled via a touch on the display 30. The user device 14 may further include a sound detector or microphone for receiving speech from a user. The control element 32 may be referred to as an input, a user interface, or a graphical user interface of the user device 14. Various user devices 14 may comprise a knob or button instead of or in addition to a touch-sensitive display as shown in FIG. 1.

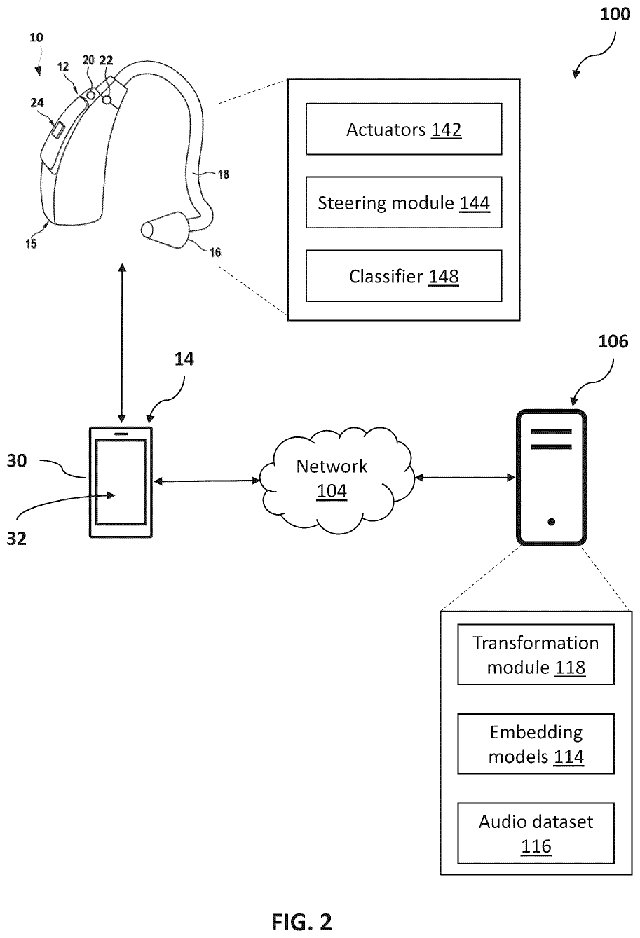

FIG. 2 schematically illustrates a network environment 100 including the hearing system 10 of FIG. 1 according to one or more embodiments. The network environment 100 may include the hearing system 10. The hearing system 10 may implement in part or in whole the various methods described herein to automatically steer the actuators of the hearing device 12. Accordingly, the hearing system 10 may include actuators 142, steering module 144, and/or classifier 148.

The actuators 142 may be configured to receive and process the audio signal generated by the input device 20 (e.g., the actuators may perform signal processing transformations on an audio signal) and provide the processed audio signal to the sound output component 22, which generates sound from the processed audio signal that is guided through the tube 18 and the second part 16 into the ear canal of the user. The actuators 142 may be implemented as a computer program executed by hearing device 12, which may comprise a central processing unit (CPU) (e.g., a processor) for processing the computer program as well as other instructions stored on a memory or electronic storage. Alternatively, the actuators 142 may comprise a sound processor implemented in hardware or a more specific DSP (digital signal processor) for modifying (e.g., transforming) the audio signal. The actuators 142 may be configured to activate/deactivate, modify, amplify, dampen, delay, and/or otherwise transform some or all the audio signal generated by the input device 20, e.g., some frequencies or frequency ranges of the audio signal depending on parameter values of parameters (which may also be referred to herein as “actuators”), which influence the amplification, the damping and/or, respectively, the delay, e.g., in correspondence with a current sound program. The parameters may be frequency dependent gain, time constant for attack and release times of compressive gain, time constant for noise canceler, time constant for dereverberation algorithms, reverberation compensation, frequency dependent reverberation compensation, mixing ratio of channels, gain compression, and/or gain shape/amplification scheme. A set of one or more of these parameters and parameter values may correspond to a predetermined sound program included in hearing device settings. In various embodiments, these parameters or other functions of the actuators 142 may be modified (or “steered”) in response to determinations made by the various embodiments described herein, e.g., in response to learned categorization of audio signals (e.g., on a hypersphere or other embedding space).

In general, sound program hearing device settings may be defined by parameters and/or parameter values defining the sound processing of the actuators 142, such as the parameters described above. Different sound programs hearing device settings are then characterized by correspondingly different parameters and parameter values. Sound program hearing device settings furthermore may comprise a list of sound processing features. The sound processing features may, for example, be a noise canceling algorithm or a beamformer, which strengths can be increased to increase speech intelligibility but with the cost of more and stronger processing artifacts. The operation of each sound program hearing device settings, sound processing features, and parameters related thereto may be steered using the methods and apparatuses described herein according to learned sound programs (e.g., actuator configurations).

The hearing device 12 may also include a steering module 144 configured to control the processing of the audio signal by the actuators 142. The steering module 144 may be implemented as a computer program executed by hearing device 12. Alternatively, the steering module 144 may comprise a control processor implemented in hardware or more specifically a DSP (digital signal processor). The steering module 144 may be configured for adjusting the parameters of the actuators 142, e.g., such that an output volume of the sound signal is adjusted based on an input volume. For example, the user may select a modifier (such as bass, treble, noise suppression, dynamic volume, etc.) and levels and/or values of the modifiers with the input means 24. From this modifier, steering commands may be created and processed as described above and below. In particular, processing parameters may be determined based on the steering command and, based on this, for example, the frequency dependent gain and the dynamic volume of the actuators 142 may be changed.

The hearing device 12 may also include a classifier 148 configured to evaluate the audio signal generated by the input device 20 for determining an optimal set of actuator configurations to apply to the audio signal. The classifier 148 may be implemented in a computer program executed by the hearing device 12. The classifier 148 may be configured to classify the audio signal generated by the input device 20 by embedding the audio signal (with one or more embedding models similar to embedding models 114), transforming the audio signal, and/or mapping (e.g., with a mapping function) the audio signal to a region from a plurality of regions on a partitioned embedding space. The classification may be based on a statistical evaluation of the audio signal and/or a machine learning algorithm that has been trained to classify the audio signal, e.g., by a training set comprising a large number of audio signals, mapping them to an embedding space, and partitioning the embedding space into regions that contain similar audio signals. So, the machine learning algorithm may be trained with several audio signals of various acoustic environments. The determinations or classifications of the classifier 148 may correspond to one or more adjustments for steering one or more actuators.

Each of the actuators 142, the steering module 144, and the classifier 148 may be embodied in hardware or software, or in a combination of hardware and software. Further, at least two of the actuators 142, the steering module 144, and the classifier 148 may be consolidated in one single module or may be provided as separate modules. In various embodiments, any of the actuators 142, the steering module 144, and/or the classifier 148 (or any of their respective functionality) may also be implemented in the hearing device 12, the user device 14, the remote server 106, or any other device that is part of a hearing system (e.g., devices used that are directly or indirectly in communication with the hearing device 12 or any other type of audio output device of a hearing system).

The network environment 100 may also include a user device 14. The user device 14 may be communicatively coupled to the hearing device 12 for data communication. The user device 14 may be used to perform at least some of the operations described herein on behalf of or in coordination with the hearing system 10. With the hearing system 10, it is possible that the above-mentioned actuators and their levels and/or values may be adjusted with the user device 14 and/or that a steering command is generated with the user device 14 and sent to the hearing device 12. This may be performed with a computer program run by and stored in the user device 14. This computer program may also provide the graphical user interface 32 on the display 30 of the user device 14. For example, for adjusting the modifier, such as volume, the graphical user interface 32 may comprise an interface element, such as a slider. When the user adjusts the slider, a steering command may be generated, which changes the sound processing of the hearing device 12. Alternatively or additionally, the user may adjust the modifier with the hearing device 12 itself, for example via the input mean 24.

The user device 14 may comprise further modules that may be or may function similarly to any or all of the actuators 142, the steering module 144, the sound detector 20 of the hearing device 12. The user device 14 may comprise a classifier that may have the same functionality as the classifier 148 explained above and/or also may be based on a machine learning algorithm.

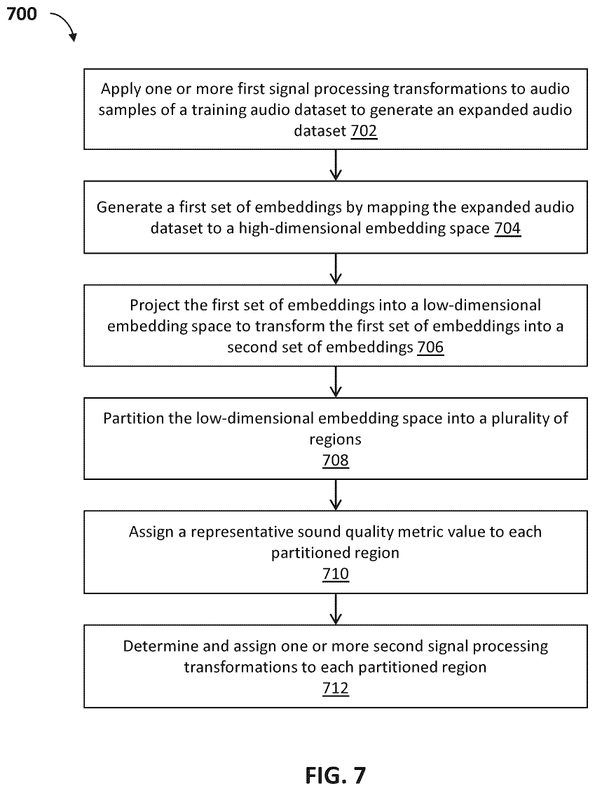

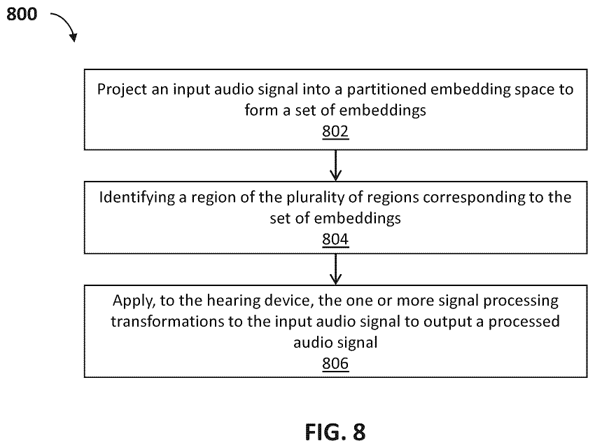

The network environment 100 may also include a remote server 106. The hearing device 12 and/or the user device 14 may communicate with each other and/or with the remote server 106 via the network 104. The various methods explained below may be carried out at least in part by the remote server 106. For example, processing tasks (e.g., training), which require a large amount of processing resources, may be outsourced from the hearing device 12 and/or the user device of 14 to the remote server 106. Accordingly, the server 106 may be used to train the classifier 148. To perform training, the server 106 may include an audio dataset 116. The audio dataset 116 may include one or more audio files, which may include audio from everyday environments that include speech, noise, and music. The audio files may be in a standardized format. For example, the audio files may be 10 seconds long, sampled at 22,050 Hz, and with a bit depth of 32. To perform training and inference, the server 106 may include one or more embedding models 114. The embedding models 114 may be configured to translate an audio file from the audio dataset 116 into a numerical representation, such as embedding vectors. The embedding models 114 may include pre-trained models (e.g., Wav2Vec, WavLM, HuBERT, BEATs) trained to translate audio data to a general-purpose, high-dimensional embedding space and may include a deep learning model trained to transform and distill embeddings from a general-purpose, high-dimensional embedding space to a low-dimensional embedding space configured to map audio samples to optimal actuator configurations, where the actuators are used to apply one or more audio signal processing transformations as described herein. In some examples, one or more corresponding models may also be implemented in classifier 148, e.g., models of a reduced complexity, which may be employed for the purpose of inference. To perform training, the server 106 may also include a transformation module 118. The transformation module 118 may be configured to apply one or more audio signal processing transformations to each audio sample in the audio dataset 116 to generate an expanded data set. The signal processing transformations may include dynamic range compression, noise suppression, beamforming for directional hearing, spectral shaping to enhance certain frequency bands, and/or the like. The expanded dataset may be used to increase the size of the dataset used to train a classifier. Training is described in further detail below with respect to FIG. 7.

The various embodiments described herein may be used with respect to the components shown in and described with respect to FIGS. 1-2. Users who wear such hearing devices may benefit from automatic adjustments to their hearing devices or other devices that they use. For example, adjustments of a hearing or other device may be to an applied gain, sound cleaning features, and other controls. Such adjustments may depend on, for example, (i) a specific situation the end user is in (e.g., a classification) which may be measured or determined based on metrics collected by various devices as described herein, and/or (ii) various settings of the devices used in a given hearing system by a user. These factors make for a complex problem with many dimensions for automatically steering the hearing device to an optimal configuration of actuators for a hearing device that is subjected to dynamic situations.

To automatically steer a hearing device to an optimal configuration of actuators, hearing devices typically utilized machine learning models supervised by labeled audio data. However, the effectiveness of this approach may be limited due to the arbitrary nature of labels and the time-consuming task of labeling audio data. For example, if the hearing device encounters a real-life situation that was not accounted for in the labeled training data, the model may not appropriately handle the situation, leaving the user to manually adjust the hearing device.

The solutions provided herein shift away from conventional supervised sound classification approaches toward an unsupervised representation learning approach to steer hearing devices. Instead of relying on predefined acoustic programs based on human-labeled sound categories, the embodiments described herein allow algorithms to independently discover acoustic patterns directly from audio data, without human intervention. By learning numerical representations that reflect intrinsic acoustic properties, the algorithm defines regions in a representation space, each corresponding directly to specific actuator configurations. This approach eliminates the need for human-defined acoustic categories, reduces biases introduced by human perception, and enables the hearing device to adapt more precisely to the user's acoustic environment. Ultimately, embodiments provide a more flexible and personalized listening experience, guided by data-driven insights rather than subjective classifications.

For example, in one or more embodiments, a model is trained using an unsupervised representation learning approach, where it is exposed to large amounts of diverse audio data without predefined labels. Instead of being told what each sound represents (via labels), the model learns by identifying patterns and similarities in the audio waveforms and/or spectral features. For instance, if two audio clips share particular acoustic properties (e.g., similar background noise levels or speech characteristics), they may be mapped to nearby regions in the embedding space. Once training is completed, these internal representations form distinct regions in the embedding space that can be directly associated with particular actuator settings, enabling the hearing device to dynamically and accurately steer actuators, such as filtering and amplification settings, based on real-time audio input.

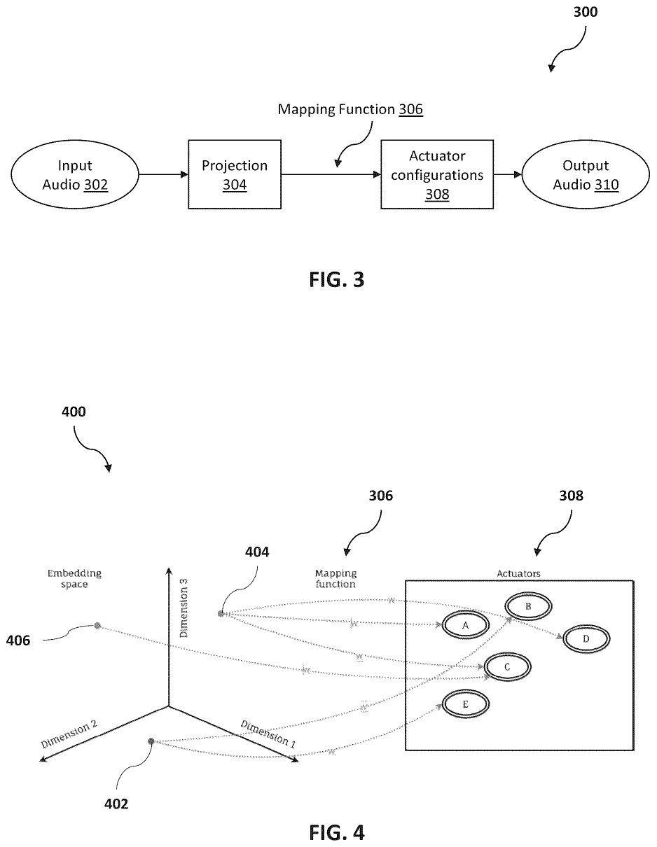

FIG. 3 schematically illustrates audio processing process 300 according to one or more embodiments. For explanatory purposes, FIG. 3 is described herein with reference to the hearing system 10 of FIG. 1, and thus the process 300 may be a computer-implemented method. However, this is merely illustrative, and features of the hearing system 10 may be performed by any other system for implementing the subject technology. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

To perform the process 300, the hearing device 10 may include a trained classifier 148, which the steering module 144 may use to infer which configurations to apply to the actuators 142 for a given audio input. The hearing device 10 may first receive input audio 302 from its input device 20. The input audio 302 may be digital and/or analog audio signals that represent sound environments including various acoustic elements, such as speech, environmental noise, or music. At this initial stage, the sound may be captured in its raw form, preserving acoustic details for further processing. In some embodiments, the input audio 302 may be received from a remote device, such as the user device 14. In some embodiments, the input audio 302 may be an audio segment of a predetermined length (e.g., 50 ms) in a continuous stream of audio data for real-time processing.

After receiving the input audio 302, the hearing device 10 projects the input audio 302 onto one or more embedding spaces 304. The classifier 148, using one or more embedding models, transforms the unstructured sound data into structured numerical data so that similar sounds are closer together on an embedding space based on their inherent acoustic properties rather than human-defined labels. The embedding space acts as a map where different regions of the embedding space correspond to a distinct set of one or more sound characteristics. For example, audio segments that share similar spectral and/or temporal features (e.g., speech in quiet versus speech in background noise) may be positioned near each other in an embedding space, while very different sounds (e.g., rustling paper versus a distant siren) may occupy separate regions. This unsupervised approach allows the hearing device 10 to discover relationships between sounds that may not be immediately obvious through traditional classification methods. In some embodiments, projecting the input audio 302 includes dividing the input audio 302 into audio samples of predetermined length (e.g., 50 ms) and projecting the audio samples onto one or more embedding spaces.

After the input audio 302 is projected onto an embedding space 304, the steering module 144 uses a learned mapping function 306 to translate positions of the input audio 302 within the embedding space into particular actuator configurations 308 to implement desired signal processing transformations for audio signals. Actuators 142 of the hearing device 10 include components of the hearing device 10 responsible for controlling audio processing parameters, such as noise reduction strength, directional microphone behavior, amplification level, and frequency-specific gain adjustments. The mapping function 306 (which may be part of the classifier 148) may be a mathematical or computational mechanism that takes the numerical representation of an audio signal (e.g., its position in the embedding space) and determines the appropriate actuator configurations that should be applied, such as gain control, noise reduction levels, or directional microphone settings. Particularly, the mapping function 306 may be pre-optimized through machine learning methods (described below with respect to FIG. 7) that align acoustic clusters in the embedding space with actuator configurations 308 determined to benefit similar acoustic conditions. As a result, whenever the input audio 302 occupies a particular region of the embedding space, the mapping function 306 may automatically identify the corresponding actuator configuration 308 for the steering module 144 to apply to the actuators 142 to optimally handle the specific acoustic scenario of the input audio 302.

Finally, the adjusted actuators 142 shape the audio processing performed by the hearing device 10, resulting in output audio 310 tailored to the user's current acoustic environment. This output audio 310 includes the processed (e.g., amplified, filtered) audio stream, which can be delivered directly to the user's ear via the tube 18 and second part 16 of the hearing device 10. Through the continuous process 300 (from raw audio capture, to projection onto the embedding space, to actuator adjustment, and finally to the output), the hearing device 10 may dynamically and automatically adapt its behavior in real-time, providing a personalized and context-sensitive auditory experience based on data-driven acoustic representations rather than manually-labeled sound categories.

FIG. 4 graphically illustrates mapping data points from an embedding space 400, e.g., corresponding to embedding space 304, to actuator configurations 308 according to one or more embodiments. An embedding space 400 is a multi-dimensional vector space that can be used to plot data points, which encodes processed information such as audio signals. The embedding space 400 enables a hearing device to represent sounds numerically in a way that highlights their salient acoustic characteristics without requiring human-defined labels. This transformation is typically achieved using machine learning models, such as neural networks, which are trained to embed audio data into vectors. Such machine learning models may include Wav2Vec, WavLM, HuBERT, and BEATs.

In the example of FIG. 4, the embedding space 400 is a Euclidean space extending in three dimensions, subsequently referred to as a 3D space, where each audio sample is represented as a point 402, 404, 406 with three features (one for each dimension), such as (1) the dominant frequency range of the sound, (2) the level of background noise, and (3) the temporal complexity (how quickly it changes over time). In this 3D embedding space, a data point 402 (corresponding to audio of speech in a quiet environment) may be placed in a region characterized by a clear frequency structure and moderate temporal complexity, whereas a data point 404 (corresponding to speech in a noisy café) may shift further along the noise dimension due to the additional background sounds. Meanwhile, data point 406 (corresponding to highly dynamic sounds like applause or rustling leaves) may be positioned in a different region due to the audio sample's rapid fluctuations in amplitude and frequency. By organizing audio in this structured manner, the hearing device 10 can make more informed decisions about how to process each incoming sound, applying appropriate actuator configurations 308 (e.g., filtering and amplification settings) based on its position in the embedding space.

In some embodiments, the audio data may be embedded into a high-dimensional space (e.g., greater than 100 dimensions) and subsequently may be further embedded into a lower-dimensional space (e.g., less than 10 dimensions) to improve efficiency, reduce computational complexity, and/or highlight certain features. High-dimensional embeddings, while rich in information, may include redundant and/or less meaningful variations that make it harder for the hearing device 10 to generalize effectively. Reducing dimensionality may help streamline the processing, allowing the hearing device 10 to make faster and more accurate decisions. Additionally, a lower-dimensional representation reduces the risk of overfitting, where the model (e.g., mapping function 306) learns noise or irrelevant details instead of focusing on fundamental acoustic properties. By distilling the embedding into a more compact form, the hearing device 10 can still capture the most relevant differences between sounds while providing smoother and more reliable steering of its actuators 142. Dimensionality reduction may be achieved using techniques such as Principal Component Analysis (PCA), t-distributed Stochastic Neighbor Embedding (t-SNE), or deep learning-based projectors.

As described above the mapping function 306 may be used to determine the actuator configurations 308 that correspond to a data point 402, 404, 406 in the embedding space 400. The mapping function 306 can take a variety of forms, such as a neural network (e.g., classifier 148) trained to learn the optimal actuator configurations for different regions of the embedding space 400. In some embodiments, the mapping function 306 could be a simple linear model, where the actuator configurations are computed as weighted combinations of the input features, or a more complex, nonlinear function such as a deep neural network, which can capture intricate relationships between sound characteristics and optimal actuator configurations. By using a learned mapping function 306, the actuators 142 in the hearing device 10 may then adjust audio processing in real time based on these settings, allowing the hearing device 10 to automatically adapt to different acoustic environments.

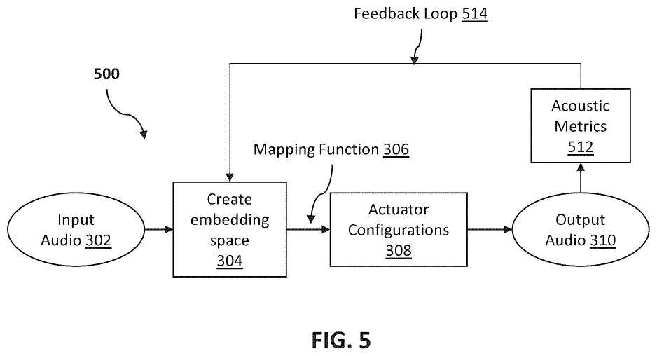

FIG. 5 schematically illustrates audio processing process 500 with feedback loop 514 according to one or more embodiments. For explanatory purposes, FIG. 5 is described herein with reference to the hearing system 10 of FIG. 1 and process 300 of FIG. 3, and thus the process 500 may be a computer-implemented method. However, this is merely illustrative, and features of the hearing system 10 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

The process 500 is an extension of the process 300 with the introduction of feedback loop 514 that continuously refines the embedding space to improve performance over time. In addition to receiving and processing audio, the hearing device 10 can generate acoustic metrics 512, which include quantitative measures that evaluate the quality and/or effectiveness of the applied actuator configurations 308. These acoustic metrics 512, such as any metric indicative of human sound perception (e.g., speech intelligibility, spatial sound distortion, consistency in a binaural audio processing) and/or user feedback, assess aspects of the output audio 310, such as speech clarity, background noise suppression, and/or overall listening comfort. The acoustic metrics 512 may be continuously monitored while modifying the regions of the embedding space and/or the actuator configurations 308 until the acoustic metrics 512 for a region reach a predetermined level.

An advantage of integrating acoustic metrics 512 into the process 500 is that the acoustic metrics 512 allow the embedding space 304 to evolve dynamically based on real-world listening conditions and user experiences. If certain types of audio are not being processed optimally (e.g., speech in a specific noisy environment being muffled or background noise reduction being too aggressive), the acoustic metric feedback can guide actuator configurations 308 to the way sounds are positioned in the embedding space, for example. This means that the hearing device 10 can restructure the learned representation and/or mapping function so that problematic audio clusters are adjusted, ensuring that the mapping function 306 applies more appropriate actuator configurations 308 in future encounters with similar sounds. In other words, the hearing device 10 continuously learns from its own performance, refining how it organizes and interprets audio data rather than relying on a static, pre-trained model. Over time, this feedback-driven adaptation can lead to more precise and individualized hearing optimization, as the hearing aid aligns more closely with both objective acoustic goals and the user's real-world needs.

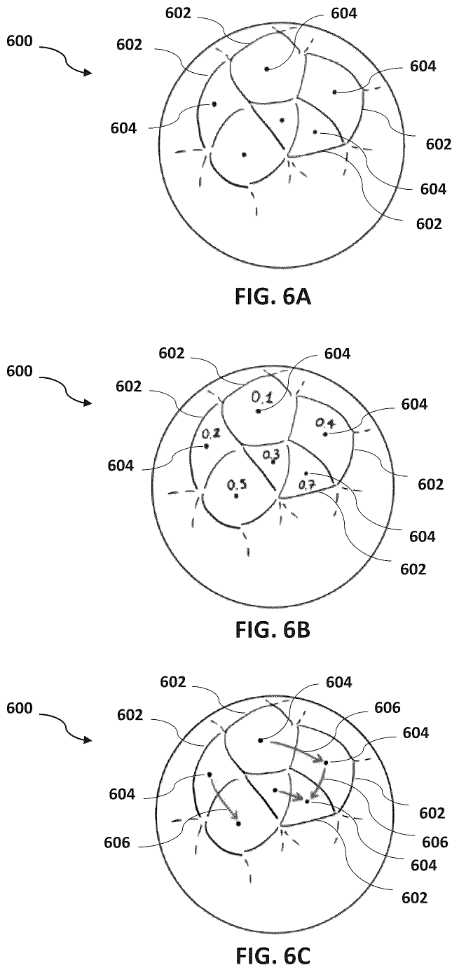

FIGS. 6A-6C graphically illustrates a hypersphere embedding space 600 according to one or more embodiments. A hypersphere embedding space 600 is a structured mathematical representation where data points (e.g., audio features) may be mapped onto the surface of a sphere rather than in a conventional Cartesian coordinate system. To illustrate, the hypersphere may be any n-dimensional sphere which may be thought of, e.g., as an n-dimensional extension of a 1-dimensional circle or a 2-dimensional sphere or any n-sphere embedded in a (n+1) dimensional Euclidean space. Unlike a standard Euclidean space, where points can be placed anywhere within an infinite range, a hypersphere constrains points to exist on its surface at a predetermined radius from its center. This structure keeps each point at a consistent relationship to others in terms of angular distance rather than absolute spatial differences. In the context of hearing devices, mapping audio representations onto a hypersphere allows for a more robust and normalized way to compare sounds so that similar acoustic properties translate into similar distances and orientations within the space.

An advantage of using a hypersphere for an embedding space is that it preserves relative relationships between data points while preventing extreme variations in scale. This may be useful in representation learning because it forces the device to focus on directional similarity rather than absolute magnitude. For example, if different speech signals share common acoustic features but vary in loudness or intensity, their placement on a hypersphere may reflect their similarity in structure rather than their raw energy levels. This prevents distortions in clustering that may arise from irrelevant amplitude differences, making the hearing device more effective in recognizing and processing sounds consistently. Additionally, the hyperspherical representation may be useful for neural networks and machine learning models, as it encourages better feature separation and stability in classification tasks. By maintaining a uniform scale across data points, the hearing device can achieve a more balanced and meaningful grouping of different types of sounds, leading to more reliable actuator mappings and improved real-time adaptation for the user. Furthermore, the embedding space can be provided in a rather compact form, e.g., in terms of a limited size, thus preventing regions (such as Voronoi cells) to extend indefinitely which could lead uncontrolled behavior.

While audio data may be directly embedded onto the embedding space 600, in some embodiments, dimensionality reduction may be used to process audio embeddings for use in a hypersphere embedding space 600, as raw audio embeddings may be high-dimensional and contain redundant or less meaningful information. Audio embeddings may originate from spectrograms or other feature-rich representations of audio data that may have hundreds or thousands of dimensions. While these high-dimensional embeddings can capture detailed acoustic properties, they may be computationally expensive to process and may introduce noise that does not contribute to meaningful processing (e.g., clustering). By applying dimensionality reduction, more relevant information may be preserved while mapping the data into a more compact, structured space (e.g., a three-dimensional hypersphere) where relationships between sounds remain meaningful.

In some embodiments, dimensionality reduction may be performed using a neural network architecture that includes a projector and a regressor. The projector network may map the high-dimensional embeddings (e.g., 128-dimensional representations) to the lower-dimensional hypersphere, e.g., a 2D hypersphere (which may be thought of as a sphere extending in a 3D Euclidean space), or any other n-dimensional sphere. A fully connected artificial neural network (ANN) with layer sizes (128, 16, 3) may also be used, where the intermediate layers reduce the dimensionality step-by-step before outputting a D=3 representation that fits within the constraints of a hyperspherical space. ReLU activations after each layer may introduce non-linearity, allowing the model to learn complex transformations, while frozen layer normalization keeps feature scaling stable throughout training. Once mapped onto the hypersphere, the regressor network may take the 3D projection and predict a quality metric (e.g., acoustic metrics 512) that evaluates how well the hearing device 10 is optimizing the audio. The regressor can be another ANN with layer sizes (8, 4, 1), meaning it first expands then compresses the input features before outputting a single scalar quality score. The entire model may be trained using mean squared error (MSE) loss so that the predicted quality metric aligns as closely as possible with real-world acoustic performance measurements.

During the training process, the server 106 may partition the embedding space 600 into a plurality of regions. In some embodiments, as shown in FIG. 6A, the embedding space 600 may be partitioned into Voronoi cells, which allows the embedding space 600 to be structured into distinct regions 602 based on a set of reference points 604. The reference points may correspond to individual data points, or to random points, or to aggregations thereof such as centroids. The server 106 may also generate a predetermined number of random points (e.g., 1000 points) uniformly distributed on the hypersphere, each of which may be a reference point 604 (also referred to as a Voronoi seed). The server 106 may partition the embedding space 600 such that each region 602 includes data points (associated with the audio dataset 116) in the embedding space 600 that are closer to one reference point 604 than any other. The partitioning provides a structured way to associate incoming audio embeddings with predefined regions 602, enabling efficient mapping to actuator settings in a hearing device. To generate the reference points 604, the server 106 may sample points from a D-dimensional Gaussian distribution (e.g., a standard normal distribution). Since a Gaussian distribution is radially symmetric, drawing samples from it provides a roughly uniform spread of points before normalization. However, as these raw points exist in an unconstrained Euclidean space, the server 106 may use L2 normalization to confine the reference points 604 to the surface of the hypersphere embedding space 600.

Once the reference points 604 are established, the server 106 may assign each data point on the hypersphere embedding space 600 (associated with the audio dataset 116) to the closest reference point 604 (e.g., based on geodesic (angular) distance). If an incoming audio embedding is mapped onto the hypersphere embedding space 600, it may be assigned to the region 602 corresponding to its nearest reference point 604. The advantage of this partitioning approach is that it enables fast and scalable classification of new audio samples without requiring complex neural network inference for every decision. Instead, once the regions 602 are established, incoming data points can be quickly assigned to their closest region 602, making the process highly efficient for real-time applications.

After the embedding space 600 is partitioned, the server 106 may define a sound quality metric value for each region 602, as shown in FIG. 6B. Since each Voronoi cell represents a distinct region 602 of the hypersphere embedding space 600 where similar sounds (e.g., from training data) are grouped together, a quality metric may be computed for each region 602 based on the audio samples (e.g., from training data) that fall within it. The quality metric may provide a numerical evaluation of how well a given sound is processed in terms of speech clarity, background noise suppression, listening comfort, and/or other auditory performance factors.

The assignment of sound quality metric values may begin by collecting real-world audio samples (e.g., training data) that have been mapped onto the hypersphere embedding space 600 and placed into their respective region 602. For each region 602, the server 106 may aggregate the sound quality metric values associated with the data points that fall within that region. Sound quality metric values may be obtained from objective signal processing evaluations, such as speech-to-noise ratios, signal distortion measures, or machine learning-based perceptual models. Additionally, in some embodiments, user feedback or adaptive learning algorithms may contribute to refining sound quality metric values over time. Once collected, the server 106 may determine the sound quality metric value for a region 602 using various aggregation methods, such as computing the mean or median quality score of the audio samples within the cell.

After assigning the sound quality metric values for each region 602, the server 106 may determine the optimal actuator configurations 308 (e.g., sound processing steps like gain adjustment, noise suppression levels, direction microphone focus) for each region 602 that result in the highest sound quality metric value for that region. To achieve this, the server 106 may first select a representative audio sample for each region 602. The audio sample may be chosen as the data point closest to the center of the corresponding region 602 so that it is representative of the sounds within the region 602. Once this reference sample is identified, the server 106 may apply possible combinations of actuator configurations in incremental variations (e.g., steps of 10% for gain control, noise suppression, and/or other actuators). Each version of the processed audio sample may then be mapped back into the hypersphere embedding space 600 (e.g., using the projector model described above) to determine which actuator configuration causes the processed audio sample to land in a region 602 with the highest sound quality metric value (606), as shown in FIG. 6C.

Alternatively, in some embodiments, the server 106 evaluates the effect of different actuator configurations by identifying the smallest possible adjustment that moves an audio sample outside of its current region 602. The server 106 may then compare the sound quality metric values of these potential new regions and select the actuator adjustment that moves the audio sample to the highest-scoring region. If multiple actuators produce transitions to high-quality regions, the system can prioritize adjustments based on user preferences, energy efficiency, or auditory perception models.

However, in cases where an audio sample already resides in a region with the highest sound quality metric value, the best processing step may simply be the identity transformation, meaning no actuator modifications are needed. This helps prevent the introduction of unnecessary processing changes that could degrade the audio signal.

The result of determining the optimal actuator configurations for each region includes a mapping function (e.g., mapping function 306) that can be used to map an embedding of an audio sample to a particular set of actuator configurations (e.g., actuator configurations 308).

FIG. 7 illustrates a flow diagram of an example process 700 for training a model for automatically steering a hearing system according to one or more implementations. For explanatory purposes, FIG. 7 is described herein with reference to the server 106 of FIG. 2, and thus the process 700 may be a computer-implemented method. However, this is merely illustrative, and features of the hearing system 10 may be performed by any other system for implementing the subject technology. Additionally, for explanatory purposes, the operations of the process 700 are described herein as occurring sequentially or linearly. However, multiple operations of the process 700 may occur in parallel. The operations of the process 700 need not be performed in the order shown, and one or more operations of the process 700 need not be performed or can be replaced by other operations.

The server 106 may be used to train a classifier 148 (e.g., a machine learning model such as a projector) that can map an audio sample to a compact, low-dimensional space (e.g., a 3D hypersphere) for selecting one or more modifications for the steering module 144 to apply to the actuators 142 of the hearing system 10.

At operation 702, the server 106 applies one or more first signal processing transformations to audio samples of a training audio dataset to generate an expanded audio dataset. The training audio dataset may include audio files of recordings in a variety of situations with speech, noise, music, and/or other ambient sounds. For example, the training audio dataset may include 1000 mono speech signals, each 10 seconds long, sampled at 22,050 Hz, and with a 32-bit resolution.

Each transformation may be applied at one or more predetermined levels so that the modifications introduced remain structured and consistent across different samples. These levels may correspond to specific parameter adjustments, such as variations in strength, frequency response, dynamic range compression, noise reduction, and/or any other relevant audio processing techniques. By modulating these transformations systematically, the server 106 can create an expanded dataset that better reflects the potential range of real-world audio inputs.

Furthermore, each transformed audio sample within the expanded dataset is associated with a sound quality metric value. The sound quality metric may be a quantitative measure of the perceptual impact of the applied transformations and may be derived from objective measures, such as signal-to-noise ratio, spectral distortion, and/or perceptual models that estimate human auditory perception.

At operation 704, the server 106 generates a first set of embeddings by mapping the expanded audio dataset to a high-dimensional embedding space (e.g., a 768-dimensional embedding space). Each audio sample in the expanded dataset is associated with an embedding in the high-dimensional space. These embeddings serve as compact numerical representations that encode salient acoustic features (e.g., spectral properties, temporal dynamics, and perceptual attributes) such that acoustically similar audio samples are positioned closer together while distinct audio samples remain separable.

In some embodiments, the server 106 may use a pre-trained deep learning (DL) model, such as wav2vec, wavLM, HuBERT, or BEATs, to generate the first set of embeddings, e.g., by mapping audio segments onto a 768-dimensional embedding space. A pre-trained model may have been trained on vast amounts of audio data to learn rich feature representations that capture, e.g., low-level signal properties and high-level semantic attributes.

At operation 706, the server 106 projects the first set of embeddings into a low-dimensional embedding space to transform the first set of embeddings into a second set of embeddings, to refine and optimize the representation of the audio features. Each embedding in the first set, which corresponds to an audio sample in the expanded dataset, is systematically mapped to a lower-dimensional space using techniques such as principal component analysis (PCA), t-SNE, or deep learning-based dimensionality reduction methods such as those described above with respect to FIGS. 6A-6C. In some embodiments, the low-dimensional embedding space is a 3D hypersphere (e.g., embedding space 600). By associating each audio sample with an embedding in the second set of embeddings, the server 106 establishes a structured, low-dimensional embedding space where similar audio samples remain proximate and distinct samples are meaningfully separated.

At operation 708, the server 106 partitions the low-dimensional embedding space into a plurality of regions (e.g., region 602). Each region corresponds to a distinct subset of the second set of embeddings, allowing for the categorization of audio samples based on their shared characteristics. In some embodiments, as described above with respect to FIGS. 6A-6C, partitioning involves the use of Voronoi tessellation, where the low-dimensional embedding space (e.g., a 3D hypersphere) is divided into Voronoi cells. Each cell (or “region”) is centered around a representative embedding, serving as a reference point for nearby embeddings. When a new audio sample (e.g., from the expanded audio dataset) is projected into the low-dimensional embedding space, it is assigned to the nearest region so that acoustically similar signals are processed in a consistent manner. This clustering approach provides a structured way to organize the embedding space while preserving meaningful relationships between data points.

At operation 710, the server 106 assigns a representative sound quality metric value to each region based on sound quality metric values associated with audio samples within each region. The assignment process involves analyzing the distribution of sound quality metric values within each region and selecting an appropriate representative value, as described above with respect to FIG. 6B. This value can be computed using various statistical methods, such as taking the mean, median, or weighted average of the individual sound quality metric values associated with embeddings in the region.

At operation 712, the server 106 determines and assigns one or more second signal processing transformations to each region in the low-dimensional embedding space. These transformations (e.g., actuator configurations 308) are selected to improve the respective sound quality metric value associated with each region so that audio samples mapped to a given region undergo processing tailored to optimize their perceptual quality.

The determination process involves analyzing the sound quality metric values of audio samples within each region and identifying signal processing transformations that lead to measurable improvements. Signal processing transformations may include noise reduction, dynamic range compression, frequency shaping, or spatial enhancements, and/or any other actuator in various configurations. By systematically evaluating the effect of different processing techniques on audio samples from each region, the server 106 selects the most effective set of signal processing transformations.

In some embodiments, the server 106 performs an exhaustive search to determine the most effective set of signal processing transformations for each region. For each region, the server 106 takes a representative data point of the region (e.g., the data point that falls closest to the center of the region) and applies various possible combinations of actuators and configuration (e.g., strength) variations to the audio sample corresponding to the representative data point. The combination that results in the highest sound quality metric value is selected as the most effective set of signal processing transformations for that region.

In some embodiments, the server 106 alternatively performs an incremental search to determine the most effective set of signal processing transformations for each region. For each region, the server 106 identifies the smallest actuator adjustment that maps the audio sample outside the region for each type of actuator. The actuator adjustment that moves the audio sample to the region with the highest sound quality metric value is selected as the most effective set of signal processing transformations for that region.

Once signal processing transformations are identified, they are assigned to their corresponding regions, forming a structured mapping (which can be represented mathematically as a mapping function 306) between acoustic characteristics and appropriate actuator configurations. When a new audio sample is projected into the embedding space and assigned to a specific region, the hearing system 10 automatically applies the corresponding signal processing transformations. This adaptive approach ensures that each audio input undergoes enhancement specifically suited to its acoustic properties, resulting in a more refined and personalized auditory experience for the user.

FIG. 8 illustrates a flow diagram of an example process 800 for automatically steering a hearing device according to one or more implementations. For explanatory purposes, FIG. 8 is described herein with reference to the hearing system 10 of FIG. 2, and thus the process 800 may be a computer-implemented method. However, this is merely illustrative, and features of the hearing system 10 may be performed by any other system for implementing the subject technology. Additionally, for explanatory purposes, the operations of the process 800 are described herein as occurring sequentially or linearly. However, multiple operations of the process 800 may occur in parallel. The operations of the process 800 need not be performed in the order shown, and one or more operations of the process 800 need not be performed or can be replaced by other operations.

At operation 802, the classifier 148 projects an input audio signal into a partitioned embedding space to form a set of embeddings. To achieve this, the classifier 148 first maps the input audio signal to a high-dimensional embedding space (e.g., 768 dimensions), generating a first set of embeddings. This initial transformation captures detailed spectral and/or temporal features of the audio signal. Following this, the classifier 148 projects the first set of embeddings into a lower-dimensional, partitioned embedding space (e.g., a 3D hypersphere embedding space 600), yielding a second set of embeddings.

This dimensionality reduction condenses and organizes the information by mapping it onto a structured space that is divided into multiple distinct regions. Each region within the partitioned embedding space groups audio samples that have similar acoustic characteristics, allowing the classifier 148 to efficiently classify and respond to diverse acoustic scenarios. Each region within the partitioned embedding space corresponds to one or more signal processing transformations (also referred to as actuators) at one or more relative strengths each associated with at least one actuator of the hearing device so that the actuators of the hearing device may carry out the signal processing transformations.

At operation 804, the classifier 148 identifies a region within the partitioned embedding space that corresponds to the set of embeddings derived from the input audio signal. Each region within the embedding is mapped to one or more signal processing transformations (e.g., via a mapping function 306), allowing the steering module 144 to apply appropriate modifications to the actuators 142 that optimize auditory perception. This classification process enables the hearing system 10 to intelligently tailor its output based on past auditory patterns and established performance metrics.

In some embodiments, the classifier 148 continuously refines the regions and/or the mapping between the regions and the signal processing transformations, improving the adaptation of the classifier 148 over time as it encounters more auditory scenarios. For example, in a feedback loop (e.g., feedback loop 514), the addition of an audio sample may cause the classifier 148 to recalculate the representative sound quality metric value for a region, further causing the classifier 148 to modify the signal processing transformations associated with the region to improve the representative sound quality metric value for the region.

At operation 806, the actuators 142 apply one or more signal processing transformations to the input audio signal to generate a processed audio signal (e.g., output audio 310) that enhances the listener's auditory experience. The signal processing transformations are selected based on the region of the partitioned embedding space to which the input signal corresponds so that the applied signal processing transformations are contextually appropriate and optimized for the detected acoustic environment.

Once the appropriate signal processing transformations have been identified, the actuators 142 modify the input audio signal in real time. The signal processing transformations may include dynamic range compression, noise suppression, beamforming for directional hearing, spectral shaping to enhance certain frequency bands, and/or the like to improve the clarity and quality of the audio signal while minimizing unwanted distortions or interferences.

The resulting processed audio signal is then output through the sound output component 22 of a hearing system 10, delivering an optimized listening experience to the wearer. By systematically applying signal processing transformations based on learned mappings, the classifier 148 provides a personalized and responsive approach to hearing enhancement. This adaptive capability allows the device to function effectively across a wide range of listening scenarios, from quiet conversations to noisy public spaces so that the wearer experiences consistent and high-fidelity auditory perception in any environment.

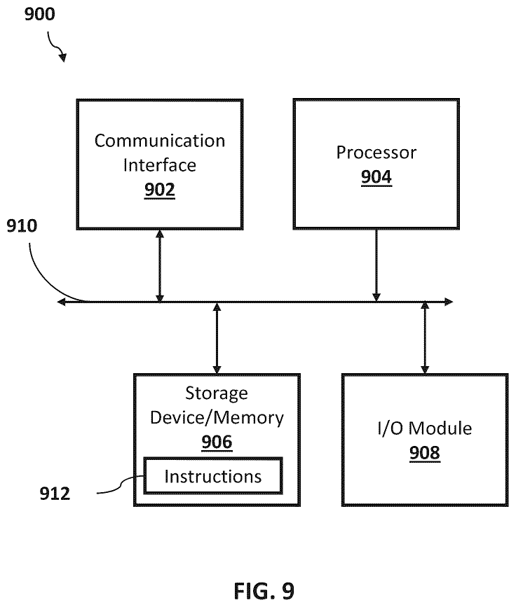

FIG. 9 illustrates an exemplary computing device 900 that may be specifically configured to perform one or more of the processes and methods described herein. Any of the systems and devices described herein may be implemented by computing device 900.

As shown in FIG. 9, computing device 900 may include a communication interface 902, a processor 904, a storage device 906, and an input/output (“I/O”) module 908 communicatively connected one to another via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may also be referred to as memory, and may include one or more data storage media, devices, or configurations and may employ any type, form, and combination of data storage media and/or device. For example, storage device 906 may include, but is not limited to, any combination of the non-volatile media and/or volatile media described herein. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

While the principles of the disclosure have been described above in connection with specific devices and methods, it is to be clearly understood that this description is made only by way of example and not as limitation on the scope of the invention. The above-described preferred embodiments are intended to illustrate the principles of the invention, but not to limit the scope of the invention. Various other embodiments and modifications to those preferred embodiments may be made by those skilled in the art without departing from the scope of the present invention that is solely defined by the claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. A method for automatically steering a hearing device, the method comprising:
projecting an input audio signal into a partitioned embedding space to form a set of embeddings, wherein the partitioned embedding space includes a plurality of regions;
identifying a region of the plurality of regions corresponding to the set of embeddings, wherein the region corresponds to one or more signal processing transformations; and
applying, to the hearing device, the one or more signal processing transformations to the input audio signal to output a processed audio signal.

2. The method of claim 1, wherein projecting the input audio signal to the partitioned embedding space comprises:
generating a first set of embeddings by mapping the input audio signal to a first embedding space; and
projecting the first set of embeddings into a second embedding space to transform the first set of embeddings into a second set of embeddings, wherein the second embedding space is the partitioned embedding space and the second set of embeddings is the set of embeddings.

3. The method of claim 2, wherein the first embedding space is a high-dimensional embedding space and the second embedding space is a low-dimensional embedding space.

4. The method of claim 2, wherein projecting the first set of embeddings to the second embedding space is performed by a machine learning model, the machine learning model comprising a projector and a regressor.

5. The method of claim 1, wherein the partitioned embedding space is a hypersphere.

6. The method of claim 1, wherein the one or more signal processing transformations include one or more of beamforming, noise cancelation, or speech enhancement.

7. The method of claim 1, wherein the one or more signal processing transformations include one or more relative strengths each associated with one or more actuators of the hearing device.

8. The method of claim 1, wherein the plurality of regions of the partitioned embedding space are Voronoi cells based on a plurality of random points.

9. The method of claim 1, wherein the one or more signal processing transformations corresponding to the region are associated with a representative sound quality metric value of the region, the region corresponds to a plurality of historical embeddings, the plurality of historical embeddings are associated with a plurality of historical audio signals, the representative sound quality metric value is based on a plurality of sound quality metric values corresponding to the plurality of historical audio signals, and the one or more signal processing transformations increases the representative sound quality metric value.

10. The method of claim 9, wherein the sound quality metric is representative of one or more of a speech intelligibility, a spatial sound distortion, a consistency in a binaural audio processing, or a measure of human sound perception.

11. The method of claim 9, wherein the representative sound quality metric value associated with the region is an average of sound quality metric values of the plurality of historical audio signals associated with the region.

12. A hearing device comprising:
an input device;
an output device;
a processor; and
a memory having non-transitory computer-readable instructions for automatically steering the hearing device, wherein, upon execution of the instructions, the processor is configured to:
receive an audio signal via the input device;
generate a first set of embeddings based on the audio signal, the first set of embeddings are associated with a first embedding space;
transform the first set of embeddings to a second set of embeddings, the second set of embeddings are associated with a second embedding space, the second embedding space includes a plurality of regions;
select a region of the plurality of regions based on the second set of embeddings;
process the audio signal with one or more signal processing transformations associated with the region; and
render the processed audio signal with the output device.

13. The hearing device of claim 12, wherein the audio signal is a first segment in a real-time audio stream, the region is a first region, and the processor is further configured to:
receive a second segment of the real-time audio stream via the input device;
generate a third set of embeddings based on the second segment, the third set of embeddings are associated with the first embedding space;
transform the third set of embeddings to a fourth set of embeddings, the fourth set of embeddings are associated with the second embedding space;
select a second region of the plurality of regions based on the fourth set of embeddings;
process the second segment with one or more signal processing transformations associated with the second region; and
render the processed audio signal with the output device.

14. The hearing device of claim 12, wherein generating the first set of embeddings is performed by a first machine learning model and transforming the first set of embeddings to the second set of embeddings is performed by a second machine learning model different from the first machine learning model.

15. The hearing device of claim 12, wherein each region of the plurality of regions corresponds to a set of one or more signal processing transformations and a set of one or more strengths corresponding to the one or more signal processing transformations.

16. The hearing device of claim 12, wherein transforming the first set of embeddings to the second set of embeddings is performed by a machine learning model trained by:
applying one or more first signal processing transformations to audio samples of a training audio dataset to generate an expanded audio dataset, wherein the one or more first signal processing transformations are applied at one or more predetermined levels, and each audio sample of the expanded audio dataset is associated with a sound quality metric value;
embedding the expanded audio dataset into a set of feature vectors, wherein a feature vector represents a point in a region of the second embedding space;
assigning a representative sound quality metric value to each region of the second embedding space based on sound quality metric values of audio samples associated with each region; and
determining and assigning a set of signal processing transformations to each region by applying one or more second signal processing transformations to audio samples associated with each region, wherein the assigned set of signal processing transformations for a region is determined based on the one or more second signal processing transformations that maximize the respective sound quality metric value for the region.

17. The hearing device of claim 16, wherein embedding the expanded audio dataset into the set of feature vectors comprises:
mapping the expanded audio dataset to a high-dimensional embedding space to form a first set of feature vectors; and
projecting the first set of feature vectors into a low-dimensional embedding space to form a second set of feature vectors, wherein each audio sample of the expanded audio dataset is associated with a feature vector in the second set of feature vectors, and the second set of feature vectors is the set of feature vectors.

18. A non-transitory computer-readable medium having instructions stored thereon that, upon execution by a computing device, cause the computing device to perform operations comprising:
applying one or more first signal processing transformations to audio samples of a training audio dataset to generate an expanded audio dataset, wherein the one or more first signal processing transformations are applied at one or more predetermined levels, and each audio sample of the expanded audio dataset is associated with a sound quality metric value;
generating a first set of embeddings by mapping the expanded audio dataset to a high-dimensional embedding space, wherein each audio sample of the expanded audio dataset is associated with an embedding in the first set of embeddings;
projecting the first set of embeddings into a low-dimensional embedding space to transform the first set of embeddings into a second set of embeddings, wherein each audio sample of the expanded audio dataset is associated with an embedding in the second set of embeddings;
partitioning the low-dimensional embedding space into a plurality of regions, wherein each region is associated with a subset of the second set of embeddings;
assigning a representative sound quality metric value to each region based on sound quality metric values associated with audio samples within each region; and
determining and assigning one or more second signal processing transformations to each region, wherein the one or more second signal processing transformations increase the respective sound quality metric value for each region.

19. The non-transitory computer-readable medium of claim 18, wherein determining the one or more second signal processing transformations for each region comprises:
selecting a representative audio sample of a region; and
applying one or more trial signal processing transformations to the representative audio sample, wherein the one or more trial signal processing transformations are applied at one or more predetermined levels, and the trial signal processing transformations that maximize the sound quality metric value of the region is the one or more second signal processing transformations.

20. The non-transitory computer-readable medium of claim 18, wherein determining the one or more second signal processing transformations for each region comprises:
selecting a representative audio sample of a region; and
applying one or more trial signal processing transformations to the representative audio sample, wherein the one or more trial signal processing transformations are applied at one or more predetermined levels, and the trial signal processing transformations that move the embedding of the representative audio sample to another region having a higher representative sound quality metric value is the one or more second signal processing transformations.
